(19) United States
(12) Patent Application Publication
(10) Pub. No.: US 2002/0145113 A1
(43) Pub. Date: Oct. 10, 2002

(54) Optical signal transmission for electron beam imaging apparatus

(75) Inventors: Jeffrey Sullivan, Berkeley, CA (US); Marian Mankos, San Francisco, CA (US); Lawrence Muray, Moraga, CA (US); Andres Fernandez, Dublin, CA (US); Steven Coyle, Alameda, CA (US)

Correspondence Address: APPLIED MATERIALS, INC., 2881 SCOTT BLVD. M/S 2061, SANTA CLARA, CA, 95050, US

(73) Assignee: Applied Materials, Inc.

(21) Appl. No.: 09/832,276

(22) Filed: Apr. 9, 2001

(51) Int. Cl. G21K 7/00

(52) U.S. Cl. 250/311

(57) ABSTRACT

An electron beam imaging apparatus capable of projecting an electron beam image on a substrate comprises a vacuum chamber having a wall and a substrate support. An electron beam source, modulator, and scanner is provided to generate, modulate, and scan one or more electron beams across the substrate. A controller is capable of generating or receiving an electrical signal to communicate with the electron beam source, modulator or scanner. One or more signal convertors are capable of converting the electrical signal to an optical signal and vice versa, the signal convertors located on either side of the wall. An optical signal carrier is capable of transmitting the optical signal through the wall of the chamber

### BACKGROUND

Embodiments of the present invention relate to an electron beam imaging apparatus to project an electron beam image on a substrate.

An electron beam imaging apparatus 100 may be used to register an electron beam image pattern on a substrate 130, as illustrated in FIG. 1. A conventional electron beam imaging apparatus 100 comprises a vacuum chamber 110 containing components 150 for generating and modulating one or more electron beams 135 to register an electron beam image on a substrate 130. The apparatus 100 may also comprise a vacuum pump 115 to evacuate and maintain a vacuum in the chamber 110. A substrate support 120 is provided for supporting the substrate 130. The multiple electron beam apparatus 100 has a number of beam source and modulator components 150 including, for example, modulated electron gun sources, beam blanking components, octupole electrodes, and beam detectors. Each component 150 may receive or transmit one or more signals during their operation.

An apparatus 100 that modulates a few tens of electron beams 135 may require thousands of separate electrical wires 170 to electrically connect the components 150 to external components and other circuitry outside the vacuum chamber 110. The individual electrical wires 170 are passed through vacuum feedthroughs 160 in the chamber wall 112. The large number of electrical wires 170 passing through the vacuum feedthroughs 160 often renders the assembled vacuum feedthroughs 160 susceptible to leakage. In addition, the complex arrangement of the vacuum feedthroughs 160 and electrical wires 170 may make it difficult to redesigning the beam column, without extensive modification of the wiring assemblies and feedthroughs 160.

Furthermore, the close proximity of the individual wires 170, which are typically closely packed in the feedthrough 160, may result in excessive electromagnetic interference between the wires 170, especially when the signals passing through the individual wires 170 are high frequency or high voltage signals. The high frequency signals carried by the wires 170 result in excessive crosstalk between the individual wires 170 making it more difficult to maintain the integrity of the signals. The high voltage signals also interfere with the nearby electron beams 135. The electromagnetic interference may also result in unacceptable modulation or distortion of the electron beams 135.

Thus it is desirable to have an electron beam imaging apparatus having a low leakage vacuum chamber. It is further desirable to reduce the number of signal transmission connections passing in and out of the vacuum chamber. It is also desirable to reduce the electromagnetic interference occurring between the signals transmitted to and from the components in the chamber. It may also be desirable to have an apparatus with a signal connection system that is readily adaptable to accommodate new circuitry without extensive modification.

### SUMMARY

An electron beam imaging apparatus comprises a vacuum chamber comprising a wall, a substrate support capable of supporting a substrate, an electron beam source capable of generating a plurality of electron beams, an electron beam modulator capable of modulating the electron beams, an electron beam scanner capable of scanning the electron beams across the substrate, a controller capable of generating or receiving an electrical signal to communicate with the electron beam source, modulator or scanner, one or more optical signal convertors capable of converting the electrical signal to an optical signal and vice versa, and an optical signal carrier capable of transmitting the optical signal through the wall of the chamber.

An electron beam imaging apparatus comprises a vacuum chamber comprising a wall, a substrate support capable of supporting a substrate, an electron beam source capable of generating a plurality of electron beams, an electron beam modulator capable of modulating the electron beams, an electron beam scanner capable of scanning the electron beams across the substrate, a controller capable of generating or receiving an electrical signal to communicate with the electron beam source, modulator or scanner, one or more optical signal convertors capable of converting the electrical signal to an optical signal and vice versa, a signal multiplexer capable of multiplexing the optical signal, an optical signal carrier capable of transmitting the multiplexed optical signal through the wall of the chamber, and a signal de-multiplexer capable of de-multiplexing the optical signal after the optical signal is transmitted through the optical signal carrier.

A method of operating an electron beam imaging apparatus, the apparatus comprising a vacuum chamber having a wall, a substrate support, an electron beam source, an electron beam modulator, and an electron beam scanner, comprises placing a substrate on the substrate support, generating a plurality of electron beams using the electron beam source, modulating the electron beams using the electron beam modulator, scanning the electron beams across the substrate using the electron beam scanner, and transmitting an optical signal through the wall to one or more of the electron beam source, modulator, or scanner.

A method of operating an electron beam imaging apparatus, the apparatus comprising a vacuum chamber having a wall, a substrate support, an electron beam source, an electron beam modulator, and an electron beam scanner, comprises placing a substrate on the substrate support, generating a plurality of electron beams using the electron beam source, modulating the electron beams using the electron beam modulator, scanning the electron beams across the substrate using the electron beam scanner, converting an electrical signal to the optical signal, multiplexing the optical signal, and transmitting the multiplexed optical signal through the wall to one or more of the electron beam source, modulator, or scanner.

### DRAWINGS

These features, aspects, and advantages of the present invention will become better understood with regard to the following description, appended claims, and accompanying drawings which illustrate examples of the invention. However, it is to be understood that each of the features can be used in the invention in general, not merely in the context of the particular drawings, and the invention includes any combination of these features, where:

FIG. 1 (prior art) is a schematic side view of a conventional electron beam imaging apparatus showing the large number of wires passing through vacuum feedthroughs in the wall of the vacuum chamber;

FIG. 2 is a schematic side view of an embodiment of an electron beam imaging apparatus having an optical signal carrier that is an optical fiber extending through the chamber wall of the apparatus;

FIG. 3 is a schematic side view of an embodiment of an electron beam imaging apparatus having an optical signal carrier comprising an optically transmissive window in a wall of the apparatus;

FIG. 4a is a schematic diagram of an exemplary circuit to convert an optical signal to an electrical signal and vice versa;

FIG. 4b is a schematic diagram of an another exemplary signal converter circuit; and

FIG. 5 is a schematic diagram of an exemplary signal path from external controller components to electron beam sources, modulators, and scanners internal to the vacuum.

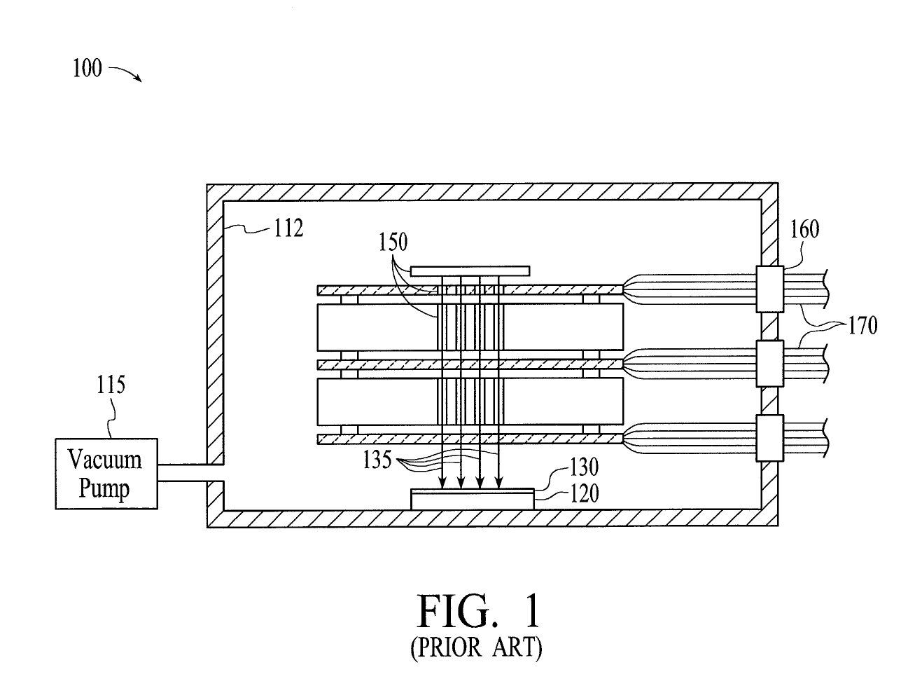

### DESCRIPTION

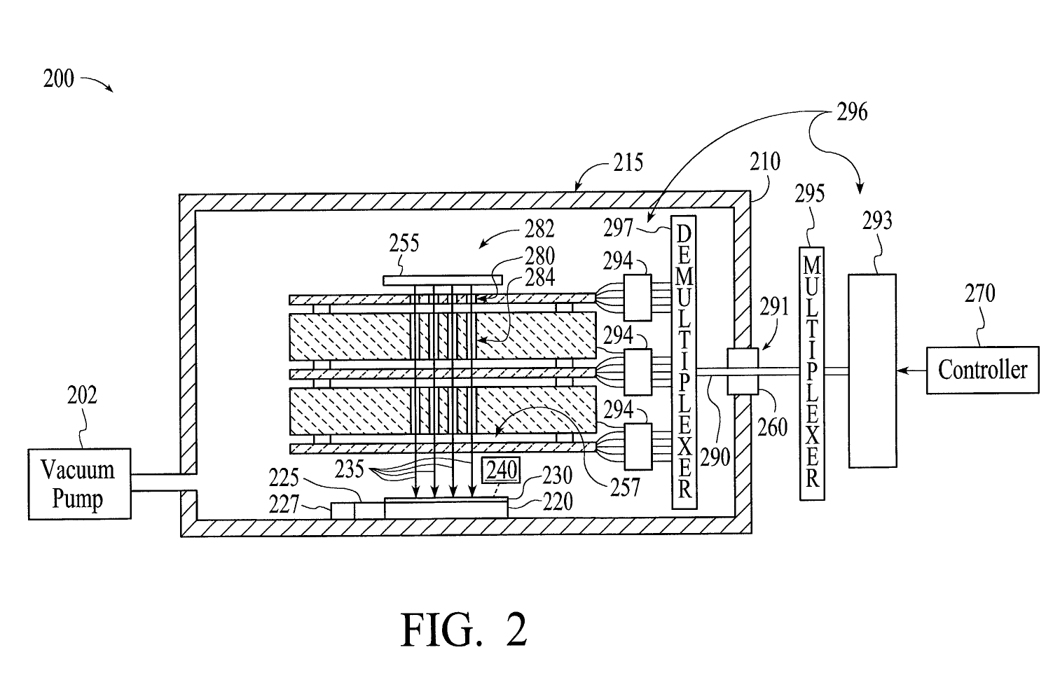

In one embodiment, an electron beam imaging apparatus 200 according to the present invention, as illustrated in FIG. 2, is capable of registering a pattern on a substrate 230. The pattern to be registered may comprise one or more single or multi-dimensional graphic representations, patterns or marks. For example, the pattern may comprise a pattern of electronic circuitry, such as for example, an integrated circuit or printed circuit board design pattern. The substrate 230 may be, for example, a semiconductor wafer, flat panel display, or a mask useful in the fabrication of integrated circuit chips on semiconductor wafers. The apparatus 200 is useful for patterning photolithographic masks. However, the exemplary embodiment is provided to illustrate the invention and should not be used to limit the scope of the invention, and it should be understood that the invention encompasses other embodiments that would be apparent to one of ordinary skill in the art.

Generally, the electron beam imaging apparatus 200 comprises a vacuum chamber 215 comprising one or more walls 210 made of, for example, aluminum. One or more vacuum pumps 202 are provided to evacuate the vacuum chamber 215 to generate a low pressure vacuum environment therein. The electron beam imaging apparatus 200 further comprises an electron beam column 282 comprising electron beam sources 255, modulators 280, and scanners 257 adapted to generate, modulate and scan one or more electron beams 235 that are projected along an electron beam pathway 284 toward the substrate 230. The electron beams 235 may be a single electron beam 235 or an array of electron beams 235. The electron beam pathway 284 may be a straight line, a curved line, a series of connected straight lines, or any other path traversed by the electron beams 235. Thus, the electron beam column 282 may be vertically oriented in a column above the substrate 230 (as shown), or may be oriented in an angled configuration (not shown), such as a right angled configuration, or may be oriented in a curved configuration (also not shown). In the version shown, the electron beam column 282 comprises a tubular electron beam pathway 284 that is traversed by an array of electron beams 235.

The apparatus 200 comprises a substrate support 220 in the vacuum chamber 215 capable of supporting a substrate 230 in the vacuum chamber 215. Support motors 225 are provided to move the support 220 to precisely position or move the substrate 230 below the electron beams 235. For example, the support motors 225 may comprise electric motors that translate the support 220 in the x and y directions along an x-y plane parallel to the substrate surface, rotate the support 220, or tilt the support 220. The apparatus 200 may further comprise support position sensors 227 capable of precisely determining the position of the support 220. For example, the support position sensors 227 may reflect a laser beam (not shown) from the support 220 and detect the reflected laser beam, where the distance between the support 220 and the position sensors 227 is determined interferometrically.

A controller 270 operates the electron beam sources 255, modulators 280, and scanners 257 and the support 220 to raster scan or vector scan the electron beams 235 across the substrate 230. Raster scanning comprises scanning the electron beams 235 across the substrate 230 in multiple passes mostly independent of the specific pattern to be registered, and modulating the intensity of the electron beams 235 according to the pattern to be registered. Vector scanning comprises scanning the electron beams 235 across the substrate 230 in a pattern selected in accordance with the pattern to be registered. In operation, a pattern is registered on the substrate 230 by the controller 270 controlling operation of the electron beams 235 and the support 220 to modulate the electron beams 235 to register the desired pattern on the substrate 230. For example, the support motors 225 and support position sensors 227 may communicate with the controller 270 to receive real-time commands from and send real-time feedback to the controller 270.

Suitable electron beam sources 255 may comprise, for example, a photocathode, field emission electron emitter, thermionic emission electron emitter, negative electron affinity emission emitter, or hot electron tunneling emission emitter. In an exemplary electron beam apparatus 200, the electron beam sources 255 provide a low energy electron beam comprising an energy of about 1 keV; however, electron beams 235 having higher energy levels of from about 10 to about 100 keV may be used to register patterns directly on substrates 230 such as semiconductor wafers.

The electron beam modulators 280 may comprise aperture components, focusing components, or demagnifying components. An aperture component (not shown) may be used to blank an electron beam 235 on or off to pulse the electron beam 235 at the desired pulsing sequence as the electron beam 235 is being scanned across the substrate 230. Electron beam aperture components may comprise, for example, electrostatic apertures or blanking plates. The electron beam focusing components are capable of changing the shape or intensity distributions of the electron beams 235 that pass through the components. Suitable electron beam focusing components may comprise, for example, electrostatic rings, stigmation components, or demagnification components.

The electron beam modulators 280 may further comprise components that are capable of some combination of aperture, focusing, or scanning functions. An octupole electrode, for example, may serve both as an electron beam aperture and a focusing component. Each octupole electrode (not shown) has eight electrostatic elements (not shown) to which voltages may be independently applied. The octupole electrode is capable of fine focusing, deflecting, and stigmating an electron beam, depending on the individual voltages applied to the electrostatic elements. In an exemplary electron beam apparatus, the modulator components 280 may include a magnetic deflection coil capable of raster scanning the electron beam, blanking plates to pass on or block off passage of the electron beam 235, and electrostatic deflection plates capable of applying a small correction just before the electron beam 235 impinges on the substrate 230.

The electron beam scanners 257 are capable of scanning or deflecting the electron beams 235. Suitable electron beam scanners 257 may comprise, for example, deflection plates or magnetic field generators. An exemplary electron beam scanner 257 comprises a magnetic field generator capable of generating a changing magnetic field to scan an electron beam along a path on the substrate 230. In another example, electrostatic deflection plates apply a small correction to an electron beam just before the electron beam 235 impinges on the substrate 230.

The electron beam imaging apparatus 100 may further comprise a fiducial mark locator 240 to determine the locations of fiducial marks (not shown) on the substrate 230. The fiducial mark locator 240 may comprise an electron detector (not shown) capable of detecting the reflected or backscattered electrons (not shown) from the fiducial mark on the substrate 230.

In one aspect of the present invention, an optical signal carrier 291 passes through the wall 210 of the vacuum chamber 215 to transmit an optical signal to or from one or more of the aforementioned electron beam sources 255, modulators 280, or scanners 257 in the vacuum chamber 215. The optical signal carrier 291 comprises a material or structure transmissive to optical radiation. The optical radiation typically has wavelengths of from about 250 nm to about 1600 nm, which covers the ultraviolet, visible, and infrared spectra. More typically the optical radiation has wavelengths in the infrared range of from about 1300 nm to about 1600 nm. The optical signal carrier 291 may be made of a material transmissive to these wavelengths; for example, commercial optical fiber is transmissive to wavelengths in the infrared range. The optical signal transmission reduces or eliminates interference problems, such as cross-talk and cross-coupling, that are associated with the transmission of electrical signals. In addition, the optical signal transmission may carry a much larger bandwidth of signals than that transported by electrical signal transmission, thereby reducing the number of signal carriers 291 that need to carry the signals through the wall 210 of the vacuum chamber 215.

In one version, as illustrated in FIG. 2, the optical signal carrier 291 comprises one or more optically transmissive fibers 290 extending through the chamber wall 210 of the vacuum chamber 215. The optical fibers 290 comprise a wall-traversing or intermediate portion 360 that traverses the wall 210, and, optionally, an internal portion 350 inside the vacuum chamber 215, and, also optionally, an external portion 370 extending out of the chamber 215. The optical fibers 290 are made of a material capable of transmitting optical signals; for example, an optical fiber 290 comprising silica glass doped with germanium is suitable for transmitting visible light. The optical fibers 290 are typically clad with a polymer jacket to protect the fiber core. The optical fibers 290 are also typically passed through a vacuum feedthrough 260 capable of forming a vacuum or gas-tight seal between the optical fibers 290 and the wall 210.

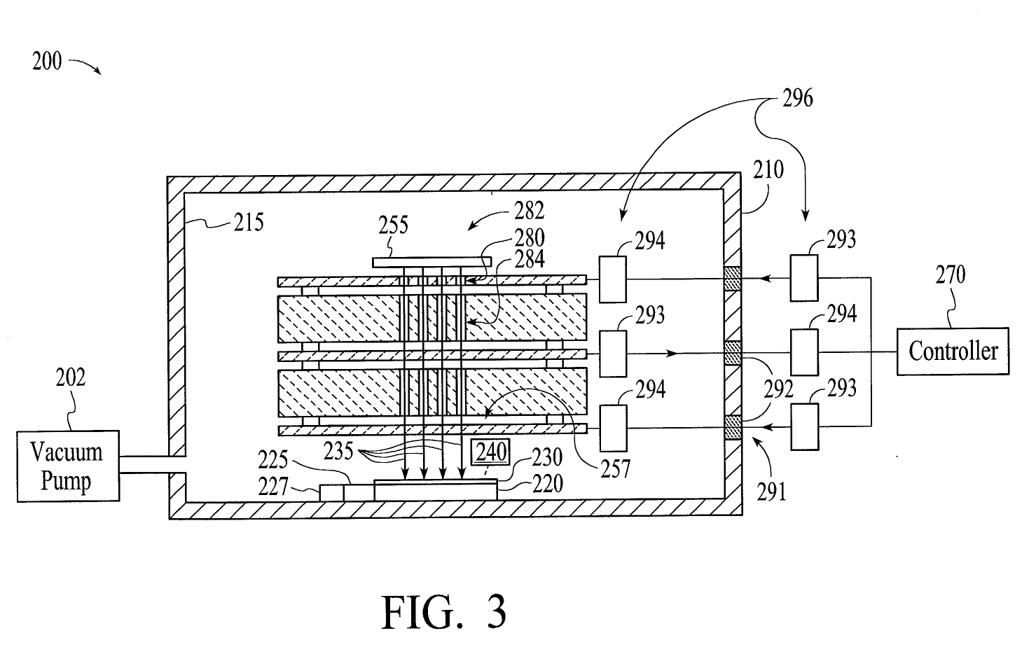

In another version, the optical signal carrier 291 comprises an optically transmissive window 292 in the wall 210 of the chamber 215, as illustrated in FIG. 3. The window 292 may be made from a material substantially transmissive to the radiation wavelengths that are transmitted to the electron beam sources 255, modulators 280, or scanners 257. For infrared, visible, and UV radiation transmissivity, the window 292 may be made of a ceramic, such as for example, one or more of Al₂O₃, Si, SiO₂, TiO₂, ZrO₂, or mixtures or compounds thereof. The ceramic may also comprise a monocrystalline material such as sapphire, which is monocrystalline alumina. Generally, the window 292 comprises a rectangular or circular shape. The surfaces of the window 292 may be polished smooth to reduce scattering of optical radiation passing through the window 292. For example, scattering of visible radiation is reduced when the window 292 has a surface roughness of less than about 1 μm. In the embodiment illustrated in FIG. 3, the window 292 is an integral portion of the wall 210 of the vacuum chamber 215 and may be positioned near an electron beam source 255, modulator 280, or scanner 257 or to an optical signal receiver 294 that receives the signals from the signal carrier and passes the signal to an electron beam source 255, modulator 280, or scanner 257. The window 292 may be positioned in the side wall of the vacuum chamber 215 (as shown) or in different portions of the vacuum chamber 215.

The electron beam imaging apparatus 200 may further comprise an optical signal converter 296 to convert electrical signals to optical signals and vice versa. The optical signal converter 296 comprises one or more optical transmitters 293 that are capable of converting an electrical signals to optical signals, and one or more optical receivers 294 that are capable of converting the optical signals back to electrical signals. Typically, control signals are converted from electrical signals to optical signals before transmitting the optical signals through the optical signal carriers 291 and to or from the electron beam sources 255, modulators 280, or scanners 257 in the vacuum chamber 215. For example, a suitable optical transmitter 293 comprises a light-emitting diode (LED) through which an electrical signal may be passed to generate an optical signal. In another version, the optical transmitter 293 comprises an acousto-optic modulator (AOM) capable of modulating the intensities of one or more laser beams generated by a distributed-feedback (DFB) laser diode. DFB lasers can overcome problems such as mode hopping that may otherwise degrade the quality of the optical signal.

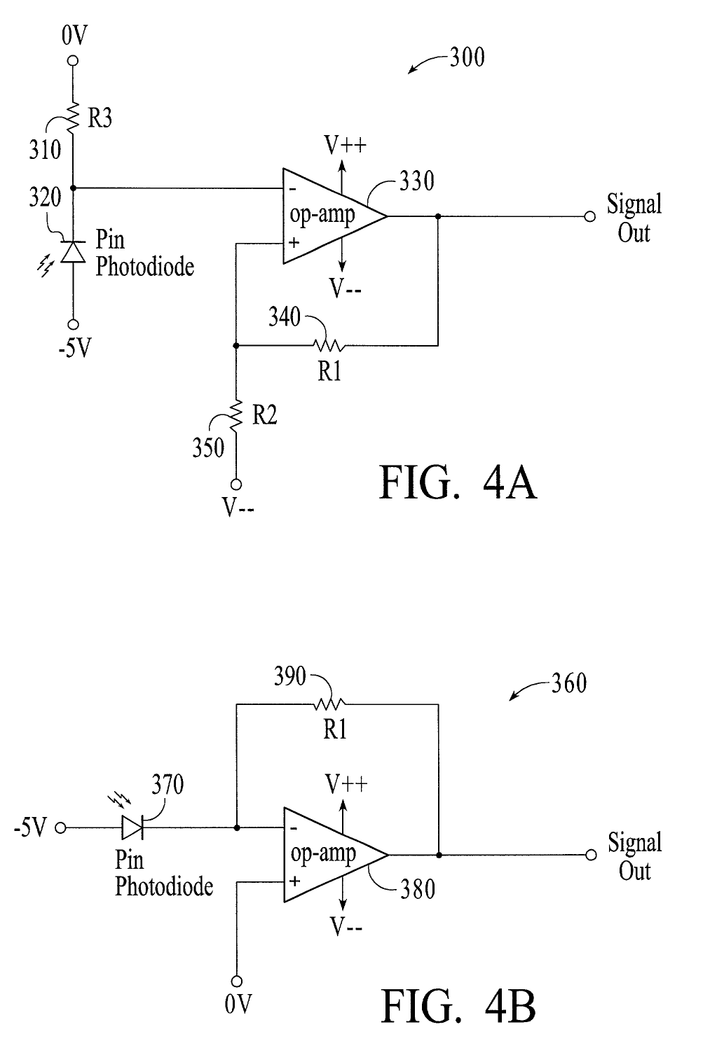

At least a portion of the optical signals may be converted back to electrical signals on either side of the vacuum chamber 215 by the optical receivers 294, for example, to operate the electron beam sources 255, modulators 280, or scanners 257 in the vacuum chamber 215 or to communicate with external components or other circuitry outside the vacuum chamber 215. Suitable optical receivers 294 for converting the optical signals back to electrical signals may comprise a light-sensitive element that generates or modulates an electrical signal according to the received optical signal. Optical receivers 294 may comprise, for example, electronic circuits comprising a photodiode, phototransistor, or other photo sensitive device. Circuit diagrams of two embodiments of optical receivers 294 that use photodiodes and operational amplifiers (op-amps) are illustrated in FIGS. 4a and 4b. FIG. 4a illustrates an embodiment 300 of a optical receiver 294 adapted to convert high-speed or digital optical signals to electrical signals. An exemplary digital optical signal may be the signal controlling an electron beam blanker component. A resistor (R3) 310 and the n junction of a photodiode 320 are connected to the negative input of an operational amp 330 (for example, an LF411 operational amp manufactured by Burr-Brown, a division of Texas Instruments, Dallas, Tex.). The other end of the resistor (R3) 310 is held at 0 V, and the p junction of the photodiode 320 is held at −5 V. A second resistor (R1) 340 and a third resistor (R2) 350 are connected to the positive input of the operational amp 330. The other end of the second resistor (R1) 340 is connected to the output of the op-amp 330, and the other end of the third resistor (R2) 350 is held at a negative voltage −V.

FIG. 4b illustrates an embodiment 360 of an optical receiver 294 adapted to convert slowly-varying or analog optical signals. An exemplary slowly-varying signal may be the signal controlling a magnetic field generator to produce a changing magnetic field to scan the electron beam 235 across the substrate 230. A photodiode 370 is connected to an operational amp 380 at the n junction of the photodiode 370 and the negative input of the operational amp 380. A resistor (R1) 390 is also connected to the negative input of the operational amp 380, and the other end of the resistor (R1) 390 is connected to the output of the operational amp 380. The positive input of the operational amp 380 is grounded.

In one version, the number of optical signals passing through the optical signal carrier 291 may be increased by combining a large number of separate optical signals into a single optical signal. The signals are combined by multiplexing the signals in a signal multiplexer 295, which essentially combines signals by generating or modulating a single signal according to the plurality of signals. Multiplexing may comprise, for example, wavelength division multiplexing or time division multiplexing. In one version, the multiplexer 295 comprises a time division multiplexer that is capable of sequentially and periodically arranging multiple signals according to a periodic clock signal. For example, the bits of multiple digital signals can be interleaved onto one signal. The clock signal is provided by a clock (not shown), such as a clock comprising a quartz crystal.

In another version, the multiplexer 295 comprises a wavelength division multiplexer. The wavelength division multiplexer combines multiple optical radiation beams of frequencies n₁, n₂, n₃, n₄, and n₅ into a single optical radiation beam having a frequency n. The wavelength division multiplexer uses the frequency of the optical radiation as a carrier wave and modulates the amplitude of the carrier wave with a signal to be transmitted to or from the electron beam sources 255, modulators 280, or scanners 257. Several embodiments of wavelength division multiplexers comprise, for example, a diffraction grating, an arrayed waveguide grating (AWG), or a fiber optic joint. The wavelength division multiplexed signals may be particularly suited to transmission over short optical transmission lines because they may be able to use a wider signal bandwidth than if they were transmitted over long optical transmission lines. In one version, it is desirable for the ratio of carrier frequency to signal frequency to be from about 1:1 to about 20:1. In frequency space, side lobes of the carrier peak contain the signal information. The side lobes may be a frequency range about the carrier frequency. The transmitted multiplexed optical signal may be mathematically represented by the form:

S(x,t)=s1(x,t)*c1(x,t)+s2(x,t)*c2(x,t)+ . . .

where s1, s2, and so on, are the multiple signals, and c1, c2, and so on, are the multiple carrier waves corresponding to those signals, and S(x,t), is the single, multiplexed signal. Two carriers may be required to be separated by enough frequency space so that the side lobes of one carrier do not overlap with the side lobes of a neighboring carrier. The highest Fourier component of the signal may be used to approximately determine a desirable frequency extent of the side lobes such that the signals do not interfere. This means that the carrier frequency is preferably substantially higher than the highest Fourier component of the signal. Because of this, it may be preferable to distribute high-frequency signals less densely over frequency space than low-frequency signals. For example, in one version, the multiplexer 295 may be adapted to separate signals by about 50 GHz for about 2.4 Gbit/s digital signals. An optical fiber 290 may be capable of transmitting a wavelength range of about 1280 nm to about 1625 nm, which corresponds to about 49.76 THz of frequency space across which to separate signals. Using a channel spacing of about 50 GHz, about 995 separate signals may be transmitted through a single optical fiber 290.

The combined optical signals may be separated by de-multiplexing in a signal de-multiplexer 297 which also may be inside or outside the vacuum chamber 215. The de-multiplexer 297 receives an input signal and yields multiple output signals that were contained in the input signal. The de-multiplexer 297 may comprise a wavelength division de-multiplexer. Exemplary optical wavelength division de-multiplexers comprise a diffraction grating, a prism, a thin film filter, a Fabry-Perot resonator, or an arrayed waveguide grating (AWG). In one embodiment, a multiplexer 295 also serves as a de-multiplexer 297, at different times or simultaneously. For example, a single diffraction grating can be used as a multiplexer 295 or a demultiplexer 297 depending on how the optical signals are transmitted to it and received from it.

The multiplexer 295 may combine the data signals inside or outside of the vacuum chamber 215. For example, as illustrated in FIG. 2, electrical signals from a controller 270 external to the vacuum chamber 215 are transmitted to an optical transmitter 293, which converts the signals to optical signals that are transmitted to a multiplexer 295, which multiplexes them. The multiplexed optical signals are then transmitted via an optical fiber 290 into the vacuum chamber 215 through the wall 210. The optical fiber 290 connects to a de-multiplexer 297 inside the vacuum chamber 215, which sends a plurality of de-multiplexed optical signals to optical receivers 294. The optical receivers 294, in turn, convert the optical signals to electrical signals and transmit the electrical signals to the internal electron beam sources 255, modulators 280, and scanners 257. Also, electrical signals may be converted to optical signals and multiplexed inside of the vacuum chamber 215 by a multiplexer 295 therein, transmitted via the optical signal carrier 291, and demultiplexed by a demultiplexer 297 outside of the vacuum chamber 215.

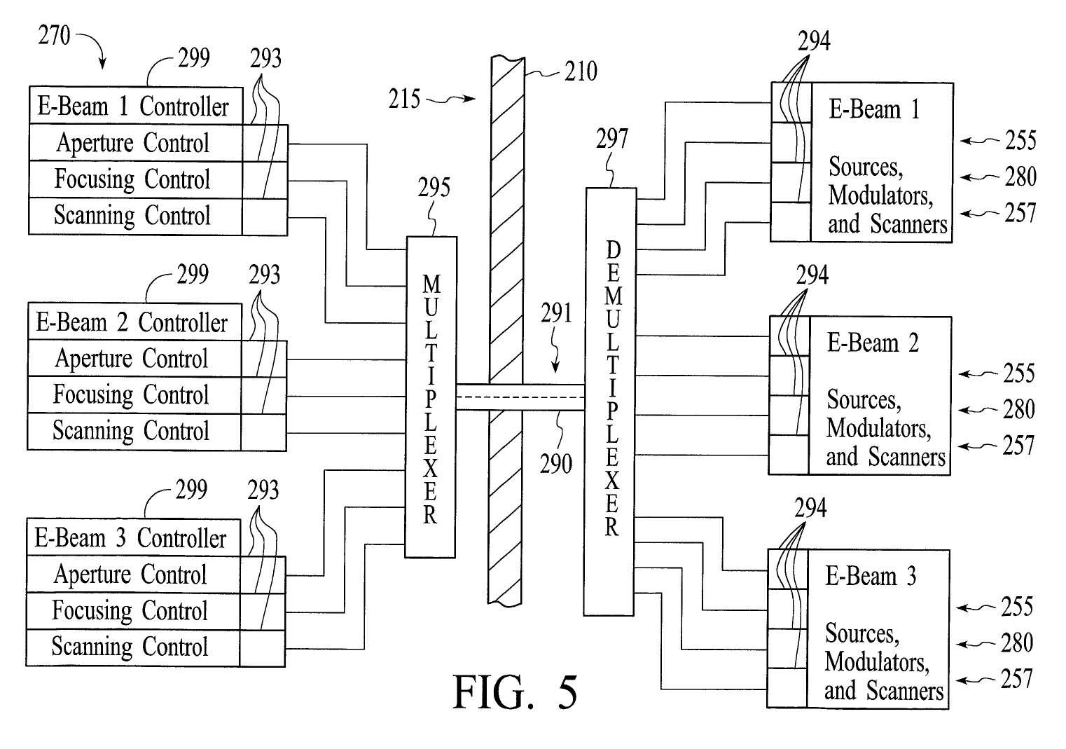

In one embodiment, illustrated in FIG. 5, electrical signals from a plurality of electron beam controllers 299 are converted to optical signals by individually corresponding optical transmitters 293. The optical signals are then transmitted to a multiplexer 295 external to the vacuum chamber 215 that is capable of multiplexing the multiple optical signals into a smaller number of optical signals, such as one optical signal. The multiplexed optical signals traverse the wall 210 via one or more optical fibers 290. The optical fibers 290 are vacuum sealed to the chamber wall 210 by a fiber optic feedthrough. The optical signals are then de-multiplexed into a larger number of optical signals by a de-multiplexer 297 inside the vacuum chamber 215. The individual de-multiplexed optical signals are then converted to electrical signals by individually corresponding optical receivers 294 comprising optical transceivers. The electrical signals then drive the electron beam sources 255, modulators 280, or scanners 257 in the vacuum chamber 215.

In one version, the wavelength division multiplexer is adapted to use carrier frequencies separated according to the frequency of the signal passed through the optical signal carrier 291. This maximizes the number of signals or bandwidth that may be transmitted through the optical fiber 290 while minimizing signal interference. For example, while the modulation of the electron beams 235 projected in the apparatus according to a 150 MHz pixel rate with 16 gray levels may consume the entire 2.4 Gbit/s rate and 50 GHz separation of a standard system, the other signals may not require such a high bandwidth. For example, signals that control the settings of the focusing components, such as lenses, may be low frequency signals, for example, of frequencies less than about 100 kHz. The electron beam scan signals may require less than 1.5 MHz of bandwidth. When a factor of about 20 is used to separate the signal bandwidth and carrier frequency, only about 3 GHz of frequency separation may be desired for all non-blanker signals. Such a bandwidth allotment using the current frequency range may allow approximately 325 electron beams to be controlled with a single optical fiber 290 capable of transmitting more than about 11,000 independent channels.

Thus, the present apparatus and method is advantageous because it allows for higher speed of pattern generation. Although the present invention has been described in considerable detail with regard to certain preferred versions thereof, other versions are possible. For example, the present invention could be used with other pattern generation devices, such as an apparatus that registers an image pattern using positive ions, laser beams or the like. Thus, the appended claims should not be limited to the description of the preferred versions contained herein.

What is claimed is:

1. An electron beam imaging apparatus comprising:
a vacuum chamber comprising a wall;
a substrate support capable of supporting a substrate;
an electron beam source capable of generating a plurality of electron beams;
an electron beam modulator capable of modulating the electron beams;
an electron beam scanner capable of scanning the electron beams across the substrate;
a controller capable of generating or receiving an electrical signal to communicate with the electron beam source, modulator or scanner;
one or more signal convertors capable of converting the electrical signal to an optical signal and vice versa, the signal convertors located on either side of the wall; and
an optical signal carrier capable of transmitting the optical signal through the wall of the chamber.

2. An apparatus according to claim 1 wherein the optical signal carrier comprises an optically transmissive fiber.

3. An apparatus according to claim 1 wherein the optical signal carrier comprises an optically transmissive window.

4. An apparatus according to claim 1 comprising a signal multiplexer is capable of multiplexing the optical signal before the optical signal is transmitted through the optical signal carrier, and a signal de-multiplexer capable of de-multiplexing the optical signal after the optical signal is transmitted through the optical signal carrier.

5. An apparatus according to claim 4 wherein the signal multiplexer and de-multiplexer operate by wavelength division multiplexing.

6. An electron beam imaging apparatus comprising:
a vacuum chamber comprising a wall;
a substrate support capable of supporting a substrate;
an electron beam source capable of generating a plurality of electron beams;
an electron beam modulator capable of modulating the electron beams;
an electron beam scanner capable of scanning the electron beams across the substrate;
a controller capable of generating or receiving an electrical signal to communicate with the electron beam source, modulator or scanner;
one or more signal convertors capable of converting the electrical signal to an optical signal and vice versa, the signal convertors located on either side of the wall;
a signal multiplexer capable of multiplexing the optical signal;
an optical signal carrier capable of transmitting the multiplexed optical signal through the wall of the chamber; and
a signal de-multiplexer capable of de-multiplexing the optical signal after the optical signal is transmitted through the optical signal carrier.

7. An apparatus according to claim 6 wherein the optical signal carrier comprises an optically transmissive fiber.

8. An apparatus according to claim 6 wherein the optical signal carrier comprises an optically transmissive window.

9. An apparatus according to claim 6 wherein the signal multiplexer and demultiplexer operate by wavelength division multiplexing.

10. A method of operating an electron beam imaging apparatus, the apparatus comprising a vacuum chamber having a wall, a substrate support, an electron beam source, an electron beam modulator, and an electron beam scanner, the method comprising:
(a) placing a substrate on the substrate support;
(b) generating a plurality of electron beams using the electron beam source;
(c) modulating the electron beams using the electron beam modulator;
(d) scanning the electron beams across the substrate using the electron beam scanner; and
(e) transmitting an optical signal through the wall to one or more of the electron beam source, modulator, or scanner.

11. A method according to claim 10 comprising transmitting the optical signal through an optically transmissive fiber extending through the chamber wall.

12. A method according to claim 10 comprising transmitting the optical signal through an optically transmissive window in the chamber wall.

13. A method according to claim 10 comprising converting an electrical signal to the optical signal and vice versa.

14. A method according to claim 10 comprising multiplexing the optical signal.

15. A method according to claim 14 comprising multiplexing by wavelength division multiplexing.

16. A method of operating an electron beam imaging apparatus, the apparatus comprising a vacuum chamber having a wall, a substrate support, an electron beam source, an electron beam modulator, and an electron beam scanner, the method comprising:
(a) placing a substrate on the substrate support;
(b) generating a plurality of electron beams using the electron beam source;
(c) modulating the electron beams using the electron beam modulator;
(d) scanning the electron beams across the substrate using the electron beam scanner; and
(e) converting an electrical signal to the optical signal, multiplexing the optical signal, and transmitting the multiplexed optical signal through the wall to one or more of the electron beam source, modulator, or scanner.

17. A method according to claim 16 comprising transmitting the optical signal through an optically transmissive fiber extending through the chamber wall.

18. A method according to claim 16 comprising transmitting the optical signal through an optically transmissive window in the chamber wall.

19. A method according to claim 16 comprising multiplexing by wavelength division multiplexing.

20. A method according to claim 16 comprising de-multiplexing the multiplexed optical signal and converting the de-multiplexed optical signal to an electrical signal.

21. A method according to claim 20 comprising de-multiplexing the optical signal by wavelength division de-multiplexing.
